(19) United States
(12) Patent Application Publication
(10) Pub. No.: US 2026/0171789 A1
(43) Pub. Date: Jun. 18, 2026

(54) BIAS CURRENT CIRCUIT, OVERCURRENT DETECTION CIRCUIT, AND SEMICONDUCTOR DEVICE

(71) Applicant: FUJI ELECTRIC CO., LTD., Kawasaki-shi (JP)

(72) Inventor: Naoto YAMAZAKI, Satoyamabe (JP)

(73) Assignee: FUJI ELECTRIC CO., LTD., Kawasaki-shi (JP)

(21) Appl. No.: 19/376,200

(22) Filed: Oct. 31, 2025

(30) Foreign Application Priority Data
Dec. 13, 2024 (JP) 2024-218840

(51) Int. Cl. H02H 9/02; H02H 1/00; H02H 7/12

(52) U.S. Cl. CPC H02H 9/025; H02H 1/0007; H02H 7/1213

(57) ABSTRACT

PROBLEM TO BE SOLVED: To provide new technique capable of performing overcurrent determination with low power consumption. ;SOLUTION: A bias current Iref made to flow through a differential amplifier part comprising an FET M01, M02, M03, and M04 is made to flow through a reference MOSFET (Metal Oxide Semiconductor Field Effect Transistor) Mr from which a voltage corresponding to a reference current can be obtained when making the reference current flow to obtain a level shift voltage Vis. A level of a detection voltage Vin corresponding to magnitude of a drain current of a main MOSFET Mm that is a target of overcurrent detection is shifted by the level shift voltage Vis, and it is applied to a gate terminal of the FET M03 that is one input of the differential amplifier part. A gate terminal of the FET M04 that is the other input of the differential amplifier part is connected to ground and is set as a round potential.

### CROSS REFERENCE TO RELATED APPLICATIONS AND INCORPORATION BY REFERENCE

This application claims benefit of priority under 35 U.S.C. § 119 based on Japanese Patent Application No. 2024-218840 filed on Dec. 13, 2024, the entire contents of which are incorporated by reference herein.

### TECHNICAL FIELD

The present disclosure relates to a bias current circuit, an overcurrent detection circuit, and a semiconductor device.

### BACKGROUND ART

A semiconductor device such as a semiconductor module constitutes a three-phase inverter bridge circuit including, for example, three insulated gate bipolar transistors (IGBTs) for power conversion which are switching power elements and three free wheeling diodes (FWDs). The semiconductor device incorporates a control IC (HVIC) for an upper arm which controls a switching element for an upper arm and a control IC (LVIC) for a lower arm which controls a switching element for a lower arm. The lower arm control IC has an overcurrent protection function.

PTL 1 discloses an overheat protection circuit having a configuration in which a reference voltage having positive temperature characteristics and a temperature voltage having negative temperature characteristics, which are obtained by a current of a current generation circuit including a first MOS transistor that connects a gate terminal and a drain terminal to each other and operates in a weak inversion region, a second MOS transistor that connects a gate terminal to the gate terminal of the first MOS transistor, has the same conductivity type as the first MOS transistor, and operates in a weak inversion region, and a first resistive element connected to a source terminal of the second MOS transistor, are compared by a comparator.

PTL 2 discloses an overcurrent detection circuit including a differential amplification unit that amplifies a potential difference between two inputs, a reference load through which a reference current flows to obtain a voltage corresponding to the reference current, in which at least a part of a bias current passing through the differential amplification unit is caused to flow through the reference load, and a voltage, which is obtained by shifting a level of a detection voltage corresponding to the magnitude of a current that is a target for overcurrent detection with a level shift voltage that is a voltage obtained by causing the current to flow through the reference load, is input to one of the two inputs of the differential amplification unit, and a predetermined reference voltage is input to the other of the two inputs of the differential amplification unit.

PTL 3 discloses an overcurrent detection circuit including a comparative voltage generation unit that generates a comparative voltage which changes according to a power supply voltage, and a comparison unit that compares a drain-source voltage of a switching transistor with the comparative voltage to generate a comparison result signal.

### CITATION LIST

### Patent Literatures

PTL 1: JP 2011-24405 A
PTL 2: JP 2008-234015 A
PTL 3: JP 2018-102023 A

### SUMMARY OF INVENTION

### Technical Problem

In the related art, a circuit configuration using a comparator or an operational amplifier is basically used as an overcurrent protection function provided in a semiconductor device. However, in such a circuit configuration, the number of internal elements tends to increase, and the power consumption of the entire semiconductor device tends to increase. As the power consumption increases, there is a possibility that the control IC for a lower arm having an overcurrent protection function generates heat. When the control IC for a lower arm generates heat, a temperature of the internal elements constituting the control IC for a lower arm also rises. Therefore, there is a problem that a detection error of the overcurrent due to the temperature dependence of the internal elements increases, and the reliability of the overcurrent protection function is lowered.

An object of the present disclosure is to provide a bias current circuit, an overcurrent detection circuit, and a semiconductor device capable of reducing temperature dependence.

### Solution to Problem

In order to achieve the above object, according to an aspect of the present disclosure, there is provided a bias current circuit including: a first switching element including a first switching control signal input terminal; a second switching element including a second switching control signal input terminal electrically connected to the first switching control signal input terminal and having a threshold voltage higher than a threshold voltage of the first switching element; and a first resistive element disposed between the first switching element and the second switching element and connected in series to the first switching element and the second switching element.

In addition, to achieve the above object, according to another aspect of the present disclosure, there is provided an overcurrent detection circuit including: the bias current circuit according to the above aspect; a constant current circuit in which a bias current is set by the bias current circuit; and a detection signal output circuit that outputs a detection signal when an overcurrent flowing through a drive element configured to drive a load is detected.

Furthermore, to achieve the above object, according to still another aspect of the present disclosure, there is provided a semiconductor device including: the drive element and the overcurrent detection circuit according to the above aspect.

### Advantageous Effects of Invention

According to each of the aspects of the present disclosure, it is possible to reduce temperature dependence.

### BRIEF DESCRIPTION OF DRAWINGS

FIG. 1 is a circuit diagram illustrating an example of a schematic configuration of a bias current circuit according to an embodiment of the present disclosure.

FIG. 2 is a circuit diagram illustrating an example of a schematic configuration of a current mirror circuit in the related art.

FIG. 3 is a block diagram illustrating an example of a schematic configuration of a semiconductor device according to one embodiment of the present disclosure.

FIG. 4 is a circuit diagram illustrating an example of a schematic configuration of an overcurrent detection circuit according to the embodiment of the present disclosure.

### DESCRIPTION OF EMBODIMENTS

Aspects of the present disclosure will be described with reference to the drawings. In each drawing, dimensions and scales of each element may be different from those of an actual product. In addition, the aspects described below are an exemplary aspect assumed when the present disclosure is implemented. Therefore, the scope of the present disclosure is not limited to the aspects exemplified below.

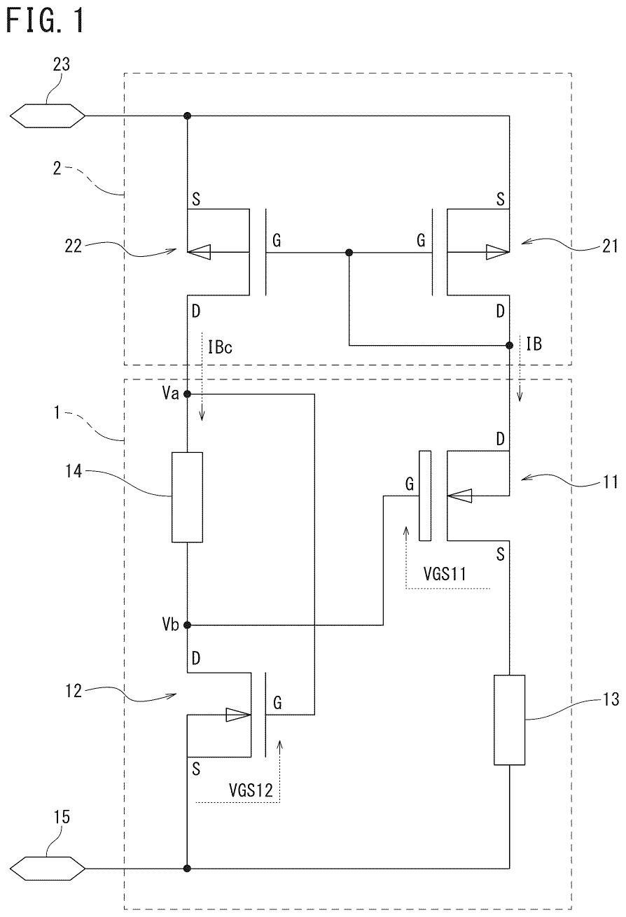

A bias current circuit, an overcurrent detection circuit, and a semiconductor device according to an embodiment of the present disclosure will be described with reference to FIGS. 1 to 4. The semiconductor device according to the present embodiment will be described by taking an intelligent power module as an example, but the semiconductor device according to the present embodiment can be applied to a device including an active element that supplies a current to a load device such as a motor.

### 1. Bias Current Circuit:

A schematic configuration of a bias current circuit according to the present embodiment will be described with reference to FIG. 1. FIG. 1 is a circuit diagram illustrating an example of a schematic configuration of a bias current circuit 1 according to the present embodiment.

As illustrated in FIG. 1, the bias current circuit 1 according to the present embodiment includes a transistor 11 (an example of a first switching element) having a gate G (an example of a first switching control signal input terminal). The bias current circuit 1 includes a transistor 12 (an example of a second switching element) having a gate G (an example of a second switching control signal input terminal) electrically connected to the gate G of the transistor 11 and having a threshold voltage higher than that of the transistor 11. The bias current circuit 1 includes a resistive element 13 (an example of a first resistive element) connected to the transistor 11 and the transistor 12 in series between the transistor 11 and the transistor 12. Further, the bias current circuit 1 includes a resistive element 14 (an example of a second resistive element) that is connected to the gate G of the transistor 11 and the gate G of the transistor 12 in series between the gate G of the transistor 11 and the gate G of the transistor 12.

Each of the transistor 11 and the transistor 12 is a field effect transistor. Each of the transistor 11 and the transistor 12 is, for example, an N-type metal oxide semiconductor (metal oxide semiconductor: MOS) field effect transistor. A source S of the transistor 11 is connected to one terminal of the resistive element 13. The gate G of the transistor 11 is connected to a drain D of the transistor 12. Therefore, a control voltage input to the gate G of the transistor 11 is a voltage of the drain D of the transistor 12. A source S of the transistor 12 is connected to the other terminal of the resistive element 13. The gate G of the transistor 12 is connected to one terminal of the resistive element 14. Therefore, a control voltage input to the gate G of the transistor 12 is a voltage of the one terminal of the resistive element 14. The drain D of the transistor 12 is connected to the other terminal of the resistive element 14. Therefore, the gate G of the transistor 11 and the gate G of the transistor 12 are electrically connected to each other via the resistive element 14. The gate G of the transistor 11 is also connected to the other terminal of the resistive element 14. The source S of the transistor 12 and the other terminal of the resistive element 13 are connected to a reference potential terminal 15 to which a reference potential of the bias current circuit 1 is input.

As illustrated in FIG. 1, a current mirror circuit 2 as a constant current circuit is connected to the bias current circuit 1. In the current mirror circuit 2, an operating point (bias point) is set by the bias current circuit 1. The current mirror circuit 2 has a transistor 21 and a transistor 22. The transistor 21 and the transistor 22 are, for example, P-type MOS field effect transistors. A drain D of the transistor 21 is connected to a drain D of the transistor 11. A source S of the transistor 21 is connected to a power supply terminal 23 to which a power supply voltage is input. A gate G of the transistor 21 is connected to a gate G of the transistor 22, the drain D of the transistor 21, and the drain D of the transistor 11. Therefore, the transistor 21 is diode-connected and operates in a saturated region. The transistor 21 outputs a bias current IB set by the bias current circuit 1 to the transistor 11.

A drain D of the transistor 22 is connected to the one terminal of the resistive element 14 and the gate G of the transistor 12. A source S of the transistor 22 is connected to the power supply terminal 23. The gate G of the transistor 22 is connected to the gate G of the transistor 21, the drain D of the transistor 21, and the drain D of the transistor 11. Therefore, the transistor 22 outputs a bias current IBc, in which the bias current IB is increased or decreased in proportion to a transistor size with respect to the transistor 21, to the resistive element 14. In the present embodiment, the transistor 21 and the transistor 22 have, for example, the same transistor size. Therefore, the transistor 22 outputs the bias current IBc having the same current level as in the transistor 21 to the resistive element 14.

Here, the bias current set by the bias current circuit 1 will be described.

As illustrated in FIG. 1, the bias current is set as “IB”, a gate-source voltage of the transistor 11 is set as “VGS11”, a gate-source voltage of the transistor 12 is set as “VGS12”, a resistance value of the resistive element 13 is set as “R13”, and a resistance value of the resistive element 14 is set as “R14”. In addition, a voltage of a connecting portion between the gate G of the transistor 12 and the one terminal of the resistive element 14 is set as “Va”, and a voltage of a connecting portion between the gate G of the transistor 11, the drain D of the transistor 12, and the other terminal of the resistive element 14 is set as “Vb”.

Since the gate-source voltage VGS12 of the transistor 12 and the voltage Va are at the same potential, a relationship of Expression (1) is established for the voltage Va.

$$Va = VGS 12 \qquad ( 1 )$$

Since the voltage Vb is at the same potential as the gate G of the transistor 11, a relationship of Expression (2) is established for the voltage Vb.

$$Vb = VGS 11 - IB \times R 13 \qquad ( 2 )$$

Since the voltage Va and the voltage Vb are potential differences between both terminals of the resistive element 14, a relationship of Expression (3) is established for the voltage Va and the voltage Vb.

$$Va - Vb = IBc \times R 14 \qquad ( 3 )$$

When Expression (1) and Expression (2) are substituted into Expression (3), a relationship of Expression (4) is obtained.

$$VGS 12 - ( VGS 11 - IB \times R 13 ) = IB \times R 14 \qquad ( 4 )$$

$$VGS 12 - IB \times R 14 = VGS 11 - IB \times R 13$$

Since the bias current IBc has the same current level as in the bias current IB, the bias current IB can be expressed by the following Expression (5) from Expression (4).

$$IB = ( VGS 12 - VGS 11 ) / ( R 13 + R 14 ) \qquad ( 5 )$$

A threshold voltage of the transistor 11 is set as “VT11”, a pinch-off voltage of the transistor 11 is set as “VP11”, a threshold voltage of the transistor 12 is set as “VT12”, and a pinch-off voltage of the transistor 12 is set as “VP12”. The pinch-off voltages VP11 and VP12 can be represented by the following Expressions (6) and (7), respectively.

$$VP 11 = VGS 11 - VT 11 \qquad ( 6 )$$

$$VP 12 = VGS 12 - VT 12 \qquad ( 7 )$$

When Expression (6) and Expression (7) are substituted into Expression (5) and the pinch-off voltage VP11 and the pinch-off voltage VP12 are equal to each other, the bias current IB can be expressed by Expression (8).

$$IB = ( VT 12 - VT 11 ) / ( R 13 + R 14 ) \qquad ( 8 )$$

As shown in Expression (8), the bias current IB set by the bias current circuit 1 is determined by the threshold voltages VT11 and VT12 of the transistors 11 and 12 and the resistance values R13 and R14 of the resistive elements 13 and 14. By forming the bias current circuit 1 within a predetermined range, the amounts of fluctuation in the threshold voltage VT11 of the transistor 11 and the threshold voltage VT12 of the transistor 12 due to an ambient temperature are substantially the same as each other, and thus a numerator of the right-hand side of Expression (8) remains almost constant regardless of a fluctuation in an ambient temperature of the bias current circuit 1. The resistance values R13 and R14 of the resistive elements 13 and 14 fluctuate in correspondence with the ambient temperature. Therefore, the fluctuation of the bias current IB depends only on the fluctuation of the resistive elements 13 and 14. As a result, the bias current circuit 1 can set the bias current IB of which temperature dependence is reduced.

The bias current circuit 1 can determine the bias current IB by the threshold voltages VT11 and VT12 of the transistors 11 and 12 and the resistance values R13 and R14 of the resistive elements 13 and 14, and does not depend on the gate-source voltages VGS11 and VGS12 of the transistors 11 and 12. Therefore, in the bias current circuit 1, the transistors 11 and 12 may operate in a weak inversion region where the gate-source voltages VGS11 and VGS12 are lower than the threshold voltages VT11 and VT12. As a result, the bias current circuit 1 can set the bias current IB with the reduced temperature dependence even when the power supply voltage input to the current mirror circuit 2 is set to a low voltage (for example, 1 V). Accordingly, the bias current circuit 1 can reduce power consumption in addition to reduction in temperature dependence.

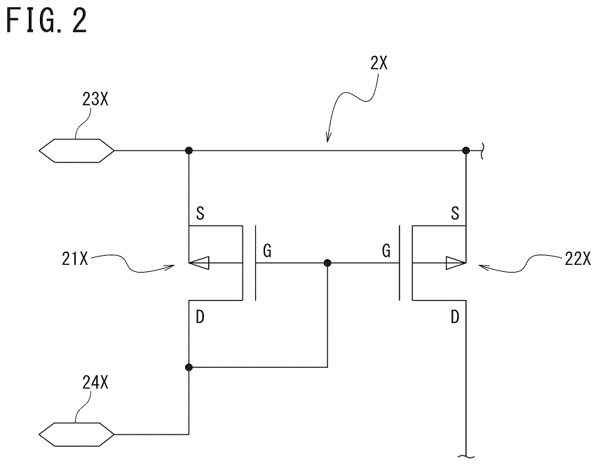

FIG. 2 is a circuit diagram illustrating an example of a configuration of a current mirror circuit 2X in the related art.

As illustrated in FIG. 2, the current mirror circuit 2X in the related art includes a diode-connected transistor 21X and a transistor 22X having a gate G connected to a gate G of the transistor 21X. The transistors 21X and 22X are, for example, P-type MOS field effect transistors. A power supply terminal 23X to which a power supply voltage is input is connected to each of sources S of the transistors 21X and 22X. A bias current circuit (not illustrated) is connected to a drain D of the transistor 21X. A predetermined circuit that operates with a current output by the current mirror circuit 2X is connected to a drain D of the transistor 22X.

Since the bias current circuit connected to the drain D of the transistor 21X has temperature dependence, a bias current fluctuates due to an ambient temperature or heat generation caused by an operation of the bias current circuit. Therefore, since an operating point of the current mirror circuit 2X fluctuates due to the ambient temperature or the like, a current output from the current mirror circuit 2X also fluctuates. As a result, there is a problem that an operation of a predetermined circuit that operates by the current output from the current mirror circuit 2X is unstable.

In addition, for example, in a case where a bias current circuit is configured by using a bandgap reference (BGR) circuit, there is a problem that the bias current circuit becomes complicated or large.

On the other hand, the bias current circuit 1 according to the present embodiment has a configuration capable of reducing the temperature dependence as described above. In addition, since the bias current circuit 1 can be configured with four elements, the amount of heat generated due to the operation can be reduced. As a result, the bias current circuit 1 can further reduce the temperature dependence. Further, the size of the bias current circuit 1 can be reduced.

As described above, the bias current circuit 1 according to the present embodiment includes the transistor 11 having the gate G, the transistor 12 that has the gate G electrically connected to the gate G of the transistor 11 and has a threshold voltage higher than the threshold voltage of the transistor 11, and the resistive element 13 connected in series to the transistor 11 and the transistor 12 between the transistor 11 and the transistor 12.

The bias current circuit 1 having such a configuration can reduce the temperature dependence.

### 2. Semiconductor Device:

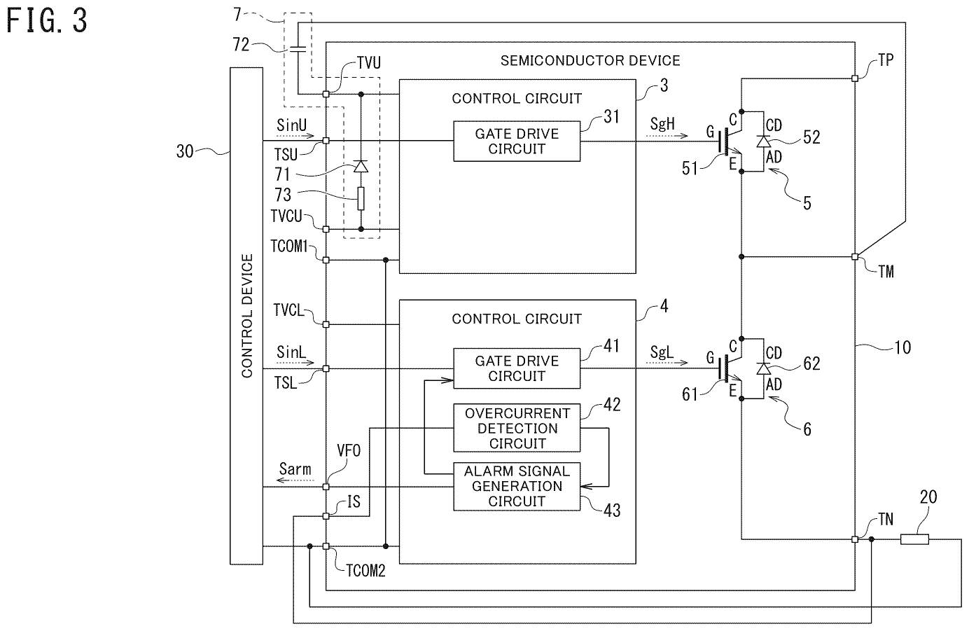

A schematic configuration of a semiconductor device according to the present embodiment will be described with reference to FIG. 3. FIG. 3 is a block diagram illustrating an example of a schematic configuration of a semiconductor device 10 according to the present embodiment.

As illustrated in FIG. 3, the semiconductor device 10 includes a control circuit 3 for an upper arm, a control circuit 4 for a lower arm, a drive element 5 for an upper arm, a drive element 6 for a lower arm, and a bootstrap circuit 7. The semiconductor device 10 includes a positive electrode-side voltage input terminal TP, a negative electrode-side voltage input terminal TN, and an intermediate terminal TM. The semiconductor device 10 includes a drive voltage terminal TVU for an upper arm, a control power supply voltage terminal TVCU for an upper arm, and a signal input terminal TSU for an upper arm. The semiconductor device 10 includes a control power supply voltage terminal TVCL for a lower arm and a signal input terminal TSL for a lower arm. The semiconductor device 10 includes common ground terminals TCOM1 and TCOM2. The semiconductor device 10 includes an overcurrent detection terminal IS and an alarm signal output terminal VFO.

The control circuit 3 for an upper arm is a high voltage integrated circuit (HVIC) that controls the drive element 5 for an upper arm on a high potential side. The control circuit 3 operates by setting a potential of a control power supply voltage for an upper arm, which is applied to the control power supply voltage terminal TVCU, to a low-level potential and by using a drive power supply voltage for an upper arm, which is generated by a bootstrap operation of the bootstrap circuit 7, as a power supply. The control circuit 3 has a gate drive circuit 31. The gate drive circuit 31 generates a gate signal SgU that controls a drive operation of an IGBT 51 provided in the drive element 5 based on an input signal SinU for an upper arm which is input to the gate drive circuit 31 via the signal input terminal TSU. The input signal SinU is input from the control device 30 that controls the semiconductor device 10.

The control circuit 4 for a lower arm is a low voltage IC (LVIC) that controls the drive element 6 for a lower arm on a low potential side. The control circuit 4 operates by using a reference potential applied to the common ground terminal TCOM2 as a reference potential and a drive power supply voltage for a lower arm which is supplied via the control power supply voltage terminal TVCL for a lower arm as a power supply. The control circuit 4 has a gate drive circuit 41. The gate drive circuit 41 generates a gate signal SgL for controlling a drive operation of an IGBT 61 provided in the drive element 6 based on an input signal SinL for a lower arm which is input via the signal input terminal TSL. The input signal SinL is input from the control device 30. The control circuit 4 has an overcurrent detection circuit 42 that detects an overcurrent flowing through the IGBT 61. The control circuit 4 has an alarm signal generation circuit 43 that generates an alarm signal Sarm for notifying that the overcurrent has been detected by the overcurrent detection circuit 42. The alarm signal Sarm is output to the control device 30 via the alarm signal output terminal VFO.

A resistive element 20 is connected between the negative electrode-side voltage input terminal TN and the common ground terminal TCOM2. A connecting portion between the negative electrode-side voltage input terminal TN and the resistive element 20, and the overcurrent detection terminal IS are connected to each other. An RC filter including a resistive element (not illustrated) connected in series to the connecting portion and the overcurrent detection terminal IS between the connecting portion and the overcurrent detection terminal IS, and a capacitor connected between the overcurrent detection terminal IS and the common ground terminal TCOM2 may be provided to prevent malfunction of overcurrent detection. The overcurrent detection terminal IS is connected to the overcurrent detection circuit 42. Although details will be described later, a voltage is generated between both terminals of the resistive element 20 by allowing a current flowing through the IGBT 61 to flow to the resistive element 20 via the negative electrode-side voltage input terminal TN. The overcurrent detection circuit 42 detects an overcurrent flowing through the IGBT 61 by using the voltage between both terminals of the resistive element 20 input from the overcurrent detection terminal IS as a detection voltage. Therefore, the resistive element 20 functions as a shunt resistor. Note that when the shunt resistor is used for the overcurrent detection of the IGBT 61 with a sense current instead of a current (main current) flowing through the IGBT 61, the shunt resistor is inserted between a center point between the negative electrode-side voltage input terminal TN and the resistive element 20, and the overcurrent detection terminal IS.

A ground potential serving as a reference potential of the entire semiconductor device 10 is input to the common ground terminal TCOM2. The common ground terminal TCOM1 is connected to the common ground terminal TCOM2. Therefore, a ground potential is input to the control circuit 3, and the control circuit 3 has the same potential as the reference potential of the control circuit 4. A DC voltage of the same potential as in the common ground terminal TCOM1 and TCOM2 is input to the control power supply voltage terminal TVCU and the control power supply voltage terminal TVCL of the semiconductor device 10.

The drive element 5 has the IGBT 51 and a free wheeling diode 52. A gate G of the IGBT 51 is connected to an output terminal of the gate drive circuit 31 provided in the control circuit 3, a collector C of the IGBT 51 is connected to the positive electrode-side voltage input terminal TP, and an emitter E of the IGBT 51 is connected to the intermediate terminal TM. The free wheeling diode 52 is connected to the IGBT 51 in reverse parallel. Specifically, a cathode CD of the free wheeling diode 52 is connected to the collector C of the IGBT 51, and an anode AD of the free wheeling diode 52 is connected to the emitter E of the IGBT 51.

The drive element 6 includes the IGBT 61 and a free wheeling diode 62. A gate G of the IGBT 61 is connected to an output terminal of a gate drive circuit 41 provided in the control circuit 4, a collector C of the IGBT 61 is connected to an emitter E of the IGBT 61, an anode AD of the free wheeling diode 62, and an intermediate terminal TM, and the emitter E of the IGBT 61 is connected to the negative electrode-side voltage input terminal TN. The free wheeling diode 62 is connected to the IGBT 61 in reverse parallel. Specifically, the cathode CD of the free wheeling diode 62 is connected to the collector C of the IGBT 61, and the anode AD of the free wheeling diode 62 is connected to the emitter E of the IGBT 61.

The drive element 5 and the drive element 6 are connected in series between the positive electrode-side voltage input terminal TP and the negative electrode-side voltage input terminal TN. The drive element 5 is disposed on a positive electrode-side voltage input terminal TP side, that is, on the high potential side. The drive element 6 is disposed on a negative electrode-side voltage input terminal TN side, that is, on the low potential side. As described above, the semiconductor device 10 includes the drive elements 5 and 6. In addition, the semiconductor device 10 includes the control circuit 4 having the overcurrent detection circuit 42. Therefore, the semiconductor device 10 includes the drive elements 5 and 6, and the overcurrent detection circuit 42 according to the present embodiment.

The bootstrap circuit 7 is a circuit that generates a drive power supply voltage for an upper arm which is supplied to the control circuit 3 by a bootstrap operation using a control power supply voltage for an upper arm which is supplied to the control circuit 3. The bootstrap circuit 7 has a bootstrap diode 71, a bootstrap capacitor 72, and a limiting resistor 73. One terminal of the limiting resistor 73 is connected to the control power supply voltage terminal TVCU. The other terminal of the limiting resistor 73 is connected to an anode of the bootstrap diode 71. A cathode of the bootstrap diode 71 is connected to one electrode of the bootstrap capacitor 72 via the drive voltage terminal TVU for an upper arm. The other electrode of the bootstrap capacitor 72 is connected to the intermediate terminal TM. As described above, the bootstrap circuit 7 is disposed between the drive voltage terminal TVU for an upper arm and the control power supply voltage terminal TVCU for an upper arm. The limiting resistor 73, the bootstrap diode 71, and the bootstrap capacitor 72 are connected in series between the drive voltage terminal TVU and the control power supply voltage terminal TVCU.

Here, the bootstrap operation will be described. In the bootstrap operation, when the IGBT 51 is in an off-state and the IGBT 61 is in an on-state, a current flows in the order of “direct current power supply (not illustrated) connected to the control power supply voltage terminal TVCU→control power supply voltage terminal TVCU→bootstrap circuit 7→drive voltage terminal TVU→intermediate terminal TM→IGBT 61→negative electrode-side voltage input terminal TN→resistive element 20→common ground terminal TCOM2”, so that the bootstrap capacitor 72 is charged and a voltage is generated at both ends thereof. At this time, the limiting resistor 73 limits the current flowing through the bootstrap diode 71. Next, when the IGBT 51 is in an on-state and the IGBT 61 is in an off-state, electric charges charged in the bootstrap capacitor 72 is discharged, and a voltage higher than a voltage of the direct current power supply connected to the control power supply voltage terminal TVCU (that is, a drive power supply voltage for an upper arm) is generated on an upper side of the bootstrap capacitor 72. As a result, since a potential of the gate G of the IGBT 51 is higher than a potential of the emitter E, the IGBT 51 can be driven.

After the drive power supply voltage for an upper arm is generated by the bootstrap operation, the IGBTs 51 and 61 are controlled by the control circuits 3 and 4 to repeat the on-state and the off-state in a state where phases are inverted from each other. As a result, the semiconductor device 10 can supply AC power from the intermediate terminal TM to a load device such as a motor. Therefore, the intermediate terminal TM functions as an output terminal of the AC power.

As described above, the semiconductor device 10 according to the present embodiment includes the drive elements 5 and 6 and the overcurrent detection circuit 42 (details will be described later) having the bias current circuit 1 according to the present embodiment.

The semiconductor device 10 having such a configuration can obtain the same effect as in the bias current circuit 1.

### 3. Overcurrent Detection Circuit:

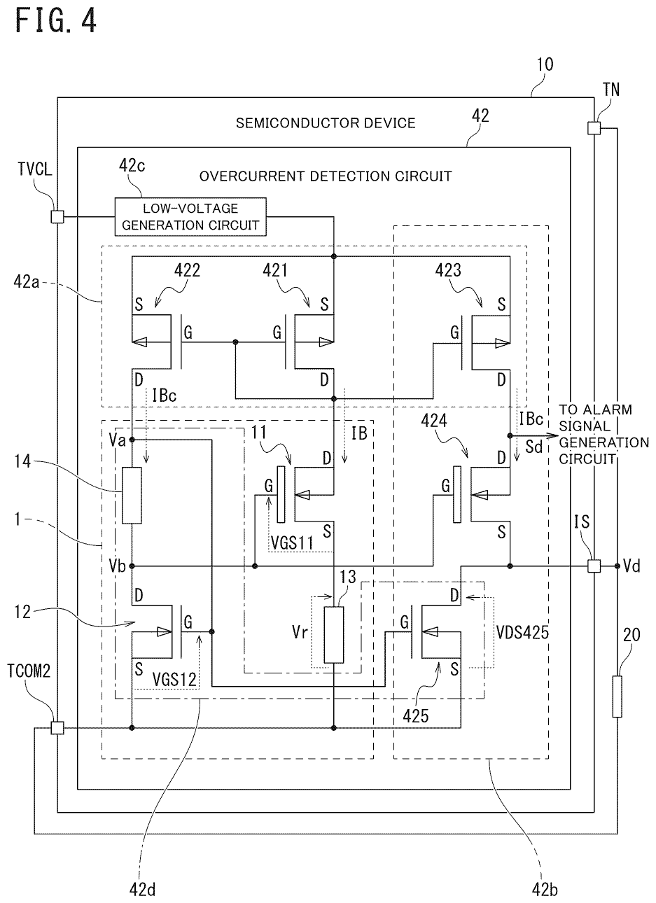

A configuration of the overcurrent detection circuit according to the present embodiment will be described with reference to FIG. 4 while referring to FIG. 3. FIG. 4 is a circuit diagram illustrating an example of a schematic configuration of the overcurrent detection circuit 42 according to the present embodiment. In FIG. 4, for ease of understanding, a part of a plurality of terminals provided in the semiconductor device 10 and the resistive element 20 are illustrated in combination.

As illustrated in FIG. 4, the overcurrent detection circuit 42 includes the bias current circuit 1 according to the present embodiment. The overcurrent detection circuit 42 includes a current mirror circuit (an example of a constant current circuit) 42a connected to the bias current circuit 1. The overcurrent detection circuit 42 includes a detection signal output circuit 42b that outputs a detection signal Sd when flowing of the overcurrent through the drive element 6 (not illustrated in FIG. 4, refer to FIG. 3) that drives a load (not illustrated) is detected. Further, the overcurrent detection circuit 42 includes a low-voltage generation circuit 42c that generates a low-voltage power supply voltage supplied to the current mirror circuit 42a. The source S of the transistor 12 and the other terminal of the resistive element 13 provided in the bias current circuit 1 are connected to the common ground terminal TCOM2. Therefore, a potential of a connecting portion between the transistor 12 and the resistive element 13 is a reference potential (for example, a ground potential) of the entire semiconductor device 10.

The current mirror circuit 42a has a transistor 421 (an example of a third switching element) that is electrically connected to the transistor 11 (an example of a first switching element), a transistor 422 (an example of a fourth switching element) that is electrically connected to the transistor 12 (an example of a second switching element), and a transistor 423 (an example of a fifth switching element). Each of the transistors 421, 422, and 423 is a field effect transistor. Each of the transistors 421, 422, and 423 is, for example, a P-type MOS field effect transistor.

The transistor 421 has a gate G (an example of a third switching control signal input terminal) connected to a side electrically connected to the transistor 11. More specifically, the gate G of the transistor 421 is connected to a drain D of the transistor 421. Therefore, a control voltage input to the gate G of the transistor 421 is a voltage of the drain D of the transistor 421. The drain D of the transistor 421 is connected to the drain D of the transistor 11. Therefore, the drain D of the transistor 11 corresponds to a side electrically connected to the transistor 11. Therefore, the gate G of the transistor 421 is connected to a side electrically connected to the transistor 11. A source S of the transistor 421 is connected to an output terminal of the low-voltage generation circuit 42c.

The transistor 422 has a gate G (an example of a fourth switching control signal input terminal) connected to the gate G of the transistor 421. Therefore, the gate G of the transistor 422 is also connected to the drain D of the transistor 421 and the drain D of the transistor 11. Therefore, a control voltage input to the gate G of the transistor 422 is a voltage of the drain D of the transistor 421. A source S of the transistor 422 is connected to an output terminal of the low-voltage generation circuit 42c. A drain D of the transistor 422 is connected to the one terminal of the resistive element 14 and the gate G of the transistor 12. Therefore, the transistor 422 is electrically connected to the transistor 12 via the resistive element 14.

The transistor 423 has a gate G (an example of a fifth switching control signal input terminal) connected to the gate G of the transistor 421 and the gate G of the transistor 422. Therefore, the gate G of the transistor 423 is also connected to the drain D of the transistor 421 and the drain D of the transistor 11. Therefore, a control voltage input to the gate G of the transistor 423 is a voltage of the drain D of the transistor 421. A source S of the transistor 423 is connected to the output terminal of the low-voltage generation circuit 42c. Therefore, the sources S of the transistors 421, 422, and 423 are connected to each other.

The current mirror circuit 42a is configured to output the bias current IBc, in which the bias current IB is increased or decreased in proportion to a transistor size with respect to the transistor 421, from the transistors 422 and 423. In the present embodiment, for example, transistor sizes of the transistors 421, 422, and 423 are set to be the same as each other. Therefore, the current mirror circuit 42a outputs a current having the same current level from each of the transistors 421, 422, and 423.

An input terminal of the low-voltage generation circuit 42c is connected to the control power supply voltage terminal TVCL. As a result, the low-voltage generation circuit 42c generates a low voltage (for example, 1 V) for operating the bias current circuit 1 in a weak inversion region by using the drive power supply voltage input via the control power supply voltage terminal TVCL. Since the overcurrent detection circuit 42 operates at a low voltage, power consumption can be reduced.

The detection signal output circuit 42b has the transistor 423, a transistor 424 (an example of a sixth switching element) connected in series to the transistor 423, and a transistor 425 (an example of a seventh switching element) connected in series to the transistor 424. A drain D of the transistor 424 is connected to a drain D of the transistor 423. A source S of the transistor 424 is connected to a drain of the transistor 425 and the overcurrent detection terminal IS. A gate G of the transistor 424 is connected to the gate G of the transistor 11, the drain D of the transistor 12, and the other terminal of the resistive element 14. Therefore, a control voltage input to the gate G of the transistor 424 is a voltage Vb of a connecting portion between the drain D of the transistor 12 and the other terminal of the resistive element 14.

A connecting portion between the drain D of the transistor 424 and the drain D of the transistor 423 is connected to the alarm signal generation circuit 43 (not illustrated in FIG. 4, refer to FIG. 3). Although details will be described later, the detection signal output circuit 42b outputs the detection signal Sd to the alarm signal generation circuit 43 from the connecting portion between the drain D of the transistor 424 and the drain D of the transistor 423. Therefore, the connecting portion between the drain D of the transistor 424 and the drain D of the transistor 423 functions as a signal output terminal of the detection signal output circuit 42b.

A source S of the transistor 425 is connected to the source S of the transistor 12, the other terminal of the resistive element 13, and the common ground terminal TCOM2. A gate G of the transistor 425 is connected to the gate G of the transistor 12, the one terminal of the resistive element 14, and the drain D of the transistor 422. Therefore, the transistors 423, 424, and 425 are connected in series between the output terminal of the low-voltage generation circuit 42c and the common ground terminal TCOM2.

One terminal of the resistive element 20 is connected to the drain D of the transistor 425 via the overcurrent detection terminal IS. Each of the other terminal of the resistive element 20 and the source S of the transistor 425 is connected to the common ground terminal TCOM2. Therefore, the detection voltage Vd that is generated between both terminals of the resistive element 20 and is input from the overcurrent detection terminal IS by allowing the current flowing through the IGBT 61 to flow through the resistive element 20 is a drain-source voltage VDS425 of the transistor 425.

A current mirror circuit 42d in which the transistor 12 is diode-connected includes the resistive element 14, the transistor 12, and the transistor 425. Therefore, the transistor 425 can operate such that the bias current IBc having substantially the same current level as the bias current IB flows as a drain current regardless of whether the detection voltage Vd and a resistance voltage Vr is high or low (that is, whether or not the overcurrent flows through the IGBT 61).

By the way, a resistance value of each of the resistive element 13 and the resistive element 20 is set such that the transistor 425 operates in a non-saturated region when the detection voltage Vd is lower than the resistance voltage Vr and operates in a saturated region when the detection voltage Vd is higher than the resistance voltage Vr. A voltage (drain voltage) of the drain D of the transistor 425 is higher in a case of operating in the saturated region as compared with a case of operating in the non-saturated region. Therefore, a voltage (source voltage) of the source S of the transistor 424 is higher in a case of operating in the saturated region as compared with a case of operating in the non-saturated region. In the overcurrent detection circuit 42, the source voltage of the transistor 424 is lower than a voltage (gate voltage) of the gate G of the transistor 424 when the transistor 425 operates in the non-saturated region. On the other hand, the source voltage of the transistor 424 is higher than the gate voltage of the transistor 424 when the transistor 425 operates in the saturated region. Therefore, the transistor 424 is in an on-state when the transistor 425 operates in the non-saturated region, and is in an off-state when the transistor 425 operates in the saturated region.

An overcurrent flowing through the IGBT 61 is larger than a current when the IGBT 61 is normally operating. Therefore, when the IGBT 61 is normally operating, the detection voltage Vd is lower than the resistance voltage Vr. On the other hand, when an overcurrent flows through the IGBT 61, the detection voltage Vd is higher than the resistance voltage Vr. Therefore, the transistor 424 is in an on-state when the IGBT 61 is normally operating, and is in an off-state when an overcurrent flows in the IGBT 61.

As a result, the transistor 424 electrically connects the connecting portion between the transistor 423 and the transistor 424 to the common ground terminal TCOM2 when the IGBT 61 is normally operating. On the other hand, the transistor 424 electrically disconnects the connecting portion between the transistor 423 and the transistor 424 from the common ground terminal TCOM2 when an overcurrent flows through the IGBT 61. As a result, when the IGBT 61 is normally operated, the detection signal output circuit 42b set a voltage level of the connecting portion between the transistor 423 and the transistor 424 to a low level so as not to output the detection signal Sd to the alarm signal generation circuit 43. On the other hand, when an overcurrent flows in the IGBT 61, the detection signal output circuit 42b sets the voltage level of the connecting portion between the transistor 423 and the transistor 424 to a high level to output the detection signal Sd having a signal level of the high level to the alarm signal generation circuit 43.

In this way, when the detection voltage Vd based on the current flowing through the drive element 6 (not illustrated in FIG. 4, refer to FIG. 3) which is input to the connecting portion of the transistor 424 and the transistor 425 is higher than the resistance voltage Vr generated by the bias current IB flowing through the resistive element 13 (an example of the first resistive element), the detection signal output circuit 42b outputs the detection signal Sd from the connecting portion of the transistor 423 and the transistor 424.

As described above, the overcurrent detection circuit 42 outputs the detection signal Sd to the alarm signal generation circuit 43 according to whether the source voltage and the gate voltage of the transistor 424 are high or low. The source voltage of the transistor 424 corresponds to the detection voltage Vd. The gate voltage of the transistor 424 corresponds to the voltage Vb represented by Expression (2) described above. Since the resistive elements 13 and 14 are fixed resistive elements, a voltage value of the voltage Vb is substantially a constant value by setting the bias current IB. The overcurrent detection circuit 42 uses the voltage Vb set by the bias current circuit 1 as a comparative voltage for comparison with the detection voltage Vd. The overcurrent detection circuit 42 causes the bias current circuit 1 and the transistors 424 and 425 to function as comparators. Since the resistive element 20 is an element that is externally attached to the semiconductor device 10, the value of the detection voltage Vd can be appropriately set.

As described above, the overcurrent detection circuit 42 according to the present embodiment includes the bias current circuit 1 according to the present embodiment, the current mirror circuit 42a in which the bias current IB is set by the bias current circuit 1, and the detection signal output circuit 42b that outputs the detection signal Sd when an overcurrent flowing through the drive elements 5 and 6 that drive the load is detected.

The overcurrent detection circuit 42 having such a configuration can obtain the same effect as the bias current circuit 1.

The present disclosure is not limited to the above-described embodiments, and various modifications can be made.

The bias current circuit 1 according to the above-described embodiment includes the resistive element 14, but the present disclosure is not limited thereto. For example, the bias current circuit 1 may not include the resistive element 14. In this case, in Expression (8), the denominator of the right-hand side is “R13”, and the bias current IB is determined by the threshold voltages VT11 and VT12 of the transistors 11 and 12 and the resistance value R13 of the resistive element 13. Therefore, the bias current circuit 1 can set the bias current IB in which the temperature dependence is reduced.

The semiconductor device 10 according to the above-described embodiment includes the drive elements 5 and 6 connected in series between the positive electrode-side voltage input terminal TP and the negative electrode-side voltage input terminal TN, but the present disclosure is not limited thereto. The semiconductor device 10 may include a plurality of phases that each have a set of two drive elements connected in series between the positive electrode-side voltage input terminal TP and the negative electrode-side voltage input terminal TN. In this case, the sets of drive elements of the plurality of the phases are connected in parallel to each other between the positive electrode-side voltage input terminal TP and the negative electrode-side voltage input terminal TN. Further, in this case, the semiconductor device 10 includes a plurality of the overcurrent detection circuits 42 such that the overcurrent detection circuits 42 are in a one-to-one relationship with the sets of the drive elements. As a result, the plurality of overcurrent detection circuits 42 can individually detect an overcurrent flowing through the plurality of sets of drive elements.

### REFERENCE SIGNS LIST

1: bias current circuit
2, 42a, 42d: current mirror circuit
3, 4: control circuit
5, 6: drive element
7: bootstrap circuit
10: semiconductor device
11, 12, 21, 22, 421, 422, 423, 424, 425: transistor
13, 14, 20: resistive element
15: reference potential terminal
23: power supply terminal
30: control device
31, 41: gate drive circuit
42: overcurrent detection circuit
42b: detection signal output circuit
42c: low-voltage generation circuit
43: alarm signal generation circuit
51, 61: IGBT
52, 62: free wheeling diode
71: bootstrap diode
72: bootstrap capacitor
73: limiting resistor
Sarm: alarm signal
Sd: detection signal
SgU, SgL: gate signal
SinL, SinU: input signal
TCOM1, TCOM2: common ground terminal
TM: intermediate terminal
TN: negative electrode-side voltage input terminal
TP: positive electrode-side voltage input terminal
TSL, TSU: signal input terminal
TVCL, TVCU: control power supply voltage terminal
TVU: drive voltage terminal
Va, Vb: voltage
Vd: detection voltage
VDS425: drain-source voltage
VFO: alarm signal output terminal
VGS11, VGS12: gate-source voltage

1. A bias current circuit comprising:
a first switching element having a first switching control signal input terminal;
a second switching element having a second switching control signal input terminal electrically connected to the first switching control signal input terminal and having a threshold voltage higher than a threshold voltage of the first switching element; and
a first resistive element disposed between the first switching element and the second switching element and connected in series to the first switching element and the second switching element.

2. The bias current circuit according to claim 1, further comprising:
a second resistive element disposed between the first switching control signal input terminal and the second switching control signal input terminal and connected in series to the first switching control signal input terminal and the second switching control signal input terminal.

3. The bias current circuit according to claim 1,
wherein each of the first switching element and the second switching element is a field effect transistor and operates in a weak inversion region.

4. The bias current circuit according to claim 2,
wherein each of the first switching element and the second switching element is a field effect transistor and operates in a weak inversion region.

5. An overcurrent detection circuit comprising:
the bias current circuit according to claim 1;
a constant current circuit connected to the bias current circuit; and
a detection signal output circuit configured to output a detection signal when an overcurrent flowing through a drive element that drives a load is detected.

6. The overcurrent detection circuit according to claim 5,
wherein the constant current circuit is a current mirror circuit having a third switching element electrically connected to the first switching element, a fourth switching element electrically connected to the second switching element, and a fifth switching element,
the third switching element has a third switching control signal input terminal connected to a side electrically connected to the first switching element,
the fourth switching element has a fourth switching control signal input terminal connected to the third switching control signal input terminal, and
the fifth switching element has a fifth switching control signal input terminal connected to the third switching control signal input terminal and the fourth switching control signal input terminal.

7. The overcurrent detection circuit according to claim 6,
wherein the detection signal output circuit has the fifth switching element, a sixth switching element connected in series to the fifth switching element, and a seventh switching element connected in series to the sixth switching element, and
when a detection voltage based on a current, which is input to a connecting portion between the sixth switching element and the seventh switching element and flows through the drive element, is higher than a resistance voltage generated when a bias current set by the bias current circuit flows through the first resistive element, the detection signal output circuit outputs the detection signal from a connecting portion between the fifth switching element and the sixth switching element.

8. A semiconductor device comprising:
the overcurrent detection circuit according to claim 5; and
the drive element.

9. A semiconductor device comprising:
the overcurrent detection circuit according to claim 6; and
the drive element.

10. A semiconductor device comprising:
the overcurrent detection circuit according to claim 7; and
the drive element.

11. An overcurrent detection circuit comprising:
the bias current circuit according to claim 2;
a constant current circuit connected to the bias current circuit; and
a detection signal output circuit configured to output a detection signal when an overcurrent flowing through a drive element that drives a load is detected.

12. An overcurrent detection circuit comprising:
the bias current circuit according to claim 3;
a constant current circuit connected to the bias current circuit; and
a detection signal output circuit configured to output a detection signal when an overcurrent flowing through a drive element that drives a load is detected.

13. An overcurrent detection circuit comprising:
the bias current circuit according to claim 4;
a constant current circuit connected to the bias current circuit; and
a detection signal output circuit configured to output a detection signal when an overcurrent flowing through a drive element that drives a load is detected.
